(19) United States
(12) Patent Application Publication
(10) Pub. No.: US 2014/0032748 A1
(43) Pub. Date: Jan. 30, 2014

(54) CONFIGURABLE NETWORK MONITORING METHODS, SYSTEMS, AND APPARATUS

(71) Applicant: Niksun, Inc., Princeton, NJ (US)

(72) Inventors: PARAG PRUTHI, Princeton, NJ (US); Viet Le, Marlton, NJ (US)

(21) Appl. No.: 13/950,982

(22) Filed: Jul. 25, 2013

Related U.S. Application Data
(60) Provisional application No. 61/675,500, filed on Jul. 25, 2012.

(51) Int. Cl. H04L 12/26

(52) U.S. Cl. CPC H04L 43/04
USPC 709/224

(57) ABSTRACT

Configurable network monitoring systems, apparatus, and methods are described. The configurable system includes storage devices, processing modules, and a system chassis housing the processing modules. Each processing module includes a processing unit, a network interface card coupled to the processing unit and configured for receiving data from a communication network, a storage controller coupled to the processing unit and configured to access a corresponding one of the storage devices, and a module chassis housing the processing unit, the network interface card, and the storage controller. The system can be reconfigured by adding/removing processing modules from the system chassis.

### CROSS REFERENCE TO RELATED APPLICATIONS

This application claims priority to U.S. Provisional application Ser. No. 61/675,500 entitled CONFIGURABLE NETWORK MONITORING METHODS, SYSTEMS, AND APPARATUS, filed on Jul. 25, 2012, the contents of which are incorporated fully herein by reference.

### BACKGROUND INFORMATION

It is routine for data to be communicated via a communication or data network. The data communicated via such networks is typically broken down into portions of information referred to as packets that are then communicated over the networks. The packets being communicated over one or more networks are referred to as network traffic.

There is an ever-present desire to monitor network traffic, e.g., to identify bottlenecks (i.e., areas of the network with slow packet throughput) and malicious traffic (e.g., denial of service and unauthorized access network attacks). The desire for improved network monitoring, systems, and apparatus persists as the volume of network traffic continues to increase and as users are increasingly dependent on high availability of internet services.

### SUMMARY OF THE INVENTION

The invention is embodied in configurable network monitoring methods, system, and apparatus for monitoring network traffic. The configurable system includes storage devices, processing modules, and a system chassis housing the processing modules. Each processing module includes a processing unit, a network interface card coupled to the processing unit and configured for receiving data from a communication network, a storage controller coupled to the processing unit and configured to access a corresponding one of the storage devices, and a module chassis housing the processing unit, the network interface card and the storage controller. The system can be reconfigured by adding/removing processing modules from the system chassis.

### BRIEF DESCRIPTION OF THE DRAWINGS

The invention is best understood from the following detailed description when read in connection with the accompanying drawing, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. The letter “n” may represent a non-specific number of elements. Also, lines without arrows connecting components may represent a bi-directional exchange between these components. This emphasizes that according to common practice, the various features of the drawings are not drawn to scale. On the contrary, the dimensions of the various features are arbitrarily expanded or reduced for clarity.

FIG. 1 is a block diagram of a configurable network monitoring system for monitoring data received from a communication network in accordance with aspects of the invention;

FIG. 2A is a block diagram of a processing module for use with the system of FIG. 1 in accordance with aspects of the invention;

FIG. 2B is a block diagram of the processing module for illustrating additional details in accordance with aspects of the invention;

FIG. 3 is a block diagram of a storage device for use with the system of FIG. 1 in accordance with aspects of the invention;

FIG. 4 is a block diagram of a system chassis with a management module and five processing modules in accordance with aspects of the invention;

FIG. 5A is a block diagram illustrating connection ports of a management module in accordance with aspects of the invention; and

FIG. 5B is a block diagram illustrating connection ports of a processing module in accordance with aspects of the invention.

### DETAILED DESCRIPTION OF INVENTIVE EMBODIMENT

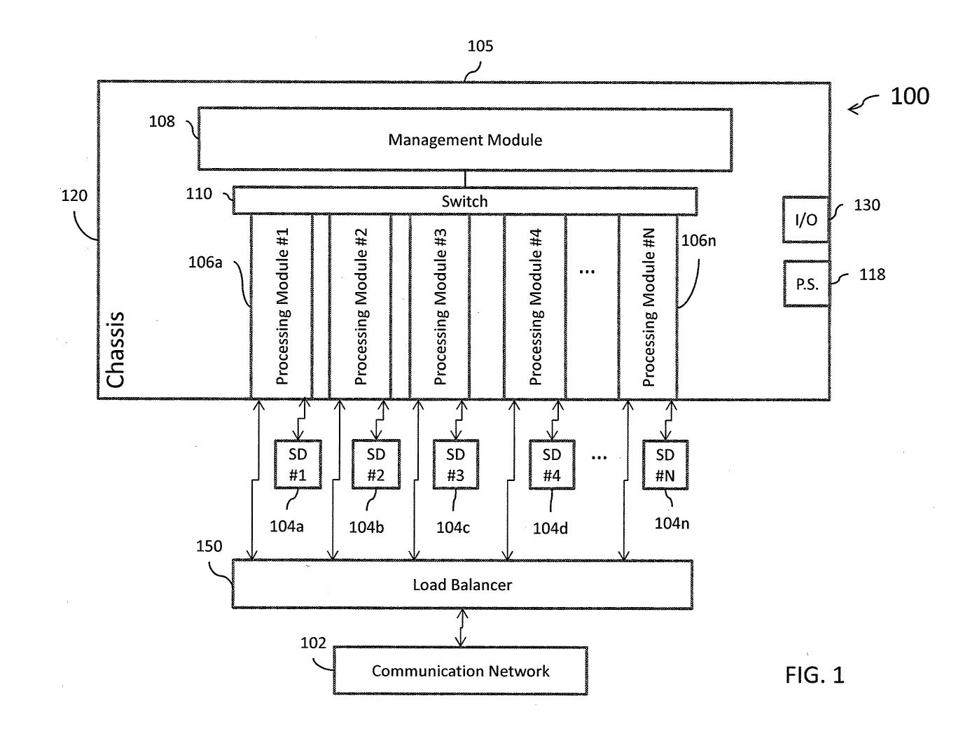

FIG. 1 depicts a configurable network monitoring system 100 for monitoring traffic on a communication network 102. Traffic on the communication network 102 may be packets of data. The communication network 102 may be essentially any type of wired or wireless network such as an intranet or an extranet, e.g., the Internet.

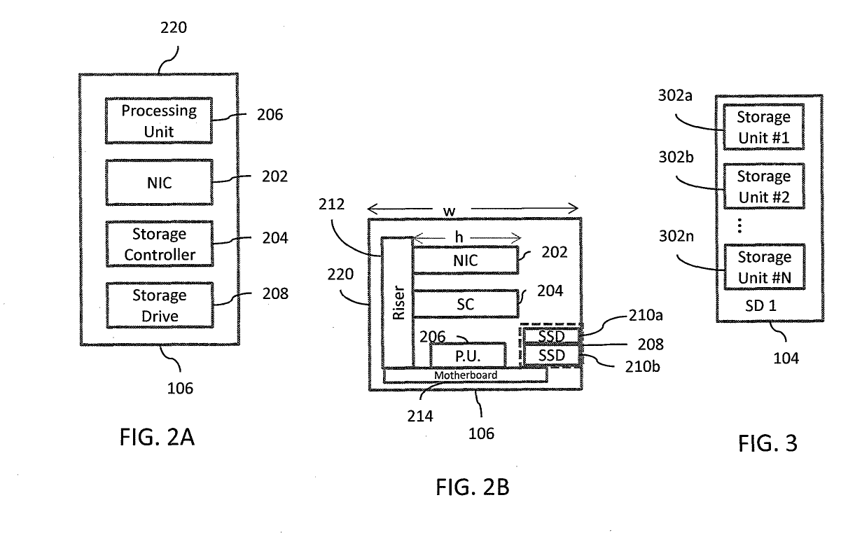

The configurable network monitoring system 100 includes a plurality of storage devices (SD) 104a-n and a network monitoring apparatus 105 including a plurality of processing modules 106a-n, which are described in further detail below with reference to FIGS. 2A, 2B, and 3. The network monitoring apparatus 105 can be configured with one or more processing modules 106 and can be reconfigured by adding, removing, and/or replacing processing modules 106. For example, the network monitoring apparatus 105 can be configured with a single processing module 106 at the time of purchase. Thereafter, additional processing modules 106 may be added to the network monitoring apparatus 105 as needed to adequately handle increases in network traffic. Thus, the configurable network monitoring system 100 is scalable to meet the needs of a user.

Although five SDs 104a-n and five processing modules 106a-n are illustrated, it is to be understood that system 100 may include more or fewer storage devices 104 and processing modules 106. Additionally, each processing module 106 may correspond to one or more storage devices 104. For example, each processing module 106 may correspond to a single storage device 104 dedicated to that processing module 106 as illustrated. In other examples, one or more of the processing modules 106 may each correspond to two or more storage devices 104 dedicated to that processing module 106.

The illustrated system 100 additionally includes a load balancer 150. The load balancer 150 is configured to distribute data received from the communication network 102 among the active processing modules 106 inserted within the chassis 120. When the load balancer 150 detects that a particular processing module is present (e.g., via a handshaking signal between the load balancer 150 and that processing module 106), the load balancer 150 will route traffic to that processing module 106.

The load balancer 150 may distribute data among the processing modules 106 responsive to characteristics of the data (e.g., based upon logical groupings of packet traffic). Additionally, the load balancer 150 may distribute the data responsive to the availability of the processing modules. For example, if a processing module is added, data may be diverted from one or more “busy” modules (e.g., determined based on packet throughput) to the newly added processing module. Conversely, when a processing module fails and/or is removed, traffic packets may be diverted to active processing modules. Suitable load balancers for use with the invention are available from Brocade of San Jose, Calif. and other vendors.

The illustrated network monitoring apparatus 105 also includes a management module 108 and a switch 110 that couples the management module 108 to the processing modules 106. The switch 110 enables communication between the management module 108 and the processing modules 106. The management module 108 may have dimensions similar to the dimensions of a processing module 106 so that the mounting hardware within the chassis 120 can be standardized to accept both types of modules. The management module 108 may provide the functionality of a NetOmni available from Niksun, Inc. of Princeton, N.J.

The management module 108 interfaces with the processing modules 106 via the switch 110. In an exemplary embodiment, the switch includes a hub and each processing module 106 and management module 108 are coupled to the hub. The management module 108 builds and maintains a network including the processing modules within the network monitoring apparatus 105. The processing modules 106 may be activated via the management module 108. The management module 108 may also interface to the plurality of processing modules 106 and provide aggregate information corresponding to the distributed traffic from the load balancer 150 to a user via a user interface (not shown) such as a graphical user interface presented on a computer display. The user interface may be a management interface such as a browser-based interface that communicates with the management module 108 via the communication network 102 or via an input/output (I/O) interface 130. Additionally, a user may interface directly to one of the processing modules 106 via a browser-based interface. The management interface may be a virtual interface including information corresponding to one or more inputs of the load balancer 150. The I/O interface 130 may include one or more I/O interfaces, one of which may be an integrated lights out (ILO) interface or another type of management interface.

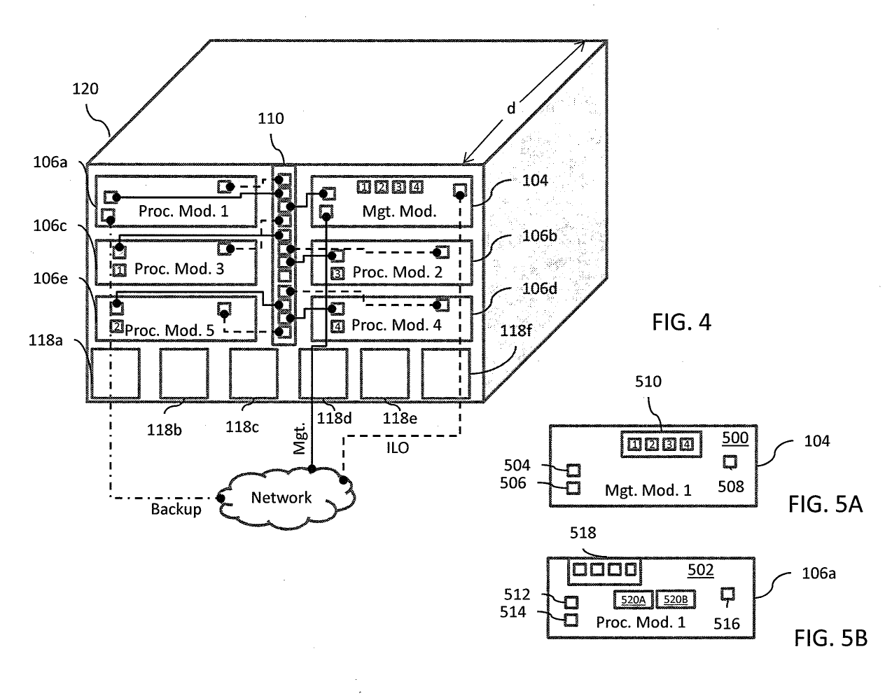

A system chassis 120 (FIGS. 1 and 4) houses the processing modules 106. Additionally, the system chassis may house the management module 108, switch 110 and/or the load balancer 150. Although the load balancer 150 is depicted outside the chassis 120, the load balancer 150 may be incorporated within the chassis thereby eliminating the need for an external load balancer.

The system chassis 120 may also include one or more power supplies (P.S.) 118 for powering one or more of the components within the chassis 120. In accordance with one aspect of the invention, fewer power supplies are needed than in conventional systems capable of handling that volume of traffic achievable with embodiments of the configurable network monitoring system 100 described herein. In an embodiment, up to six 1000W power supplies are used (e.g., three required power supplies plus up to three redundant power supplies). The power supplies may be D.C. or A.C. power supplies and may be load balanced such that if one or more power supplies fail, the power load for the components within the system chassis 120 will be shared among the remaining power supplies.

FIG. 2A depicts a processing module 106 (e.g., processing module 106a) in accordance with aspects of the invention. Each processing module 106 includes a network interface card (NIC) 202, a storage controller 204, and a processing unit 206. Each processing module 106 may optionally also include a storage drive 208. Each of the processing modules 106 may provide the functionality of a NetDetector and/or NetVCR available from Niksun, Inc. of Princeton, N.J. In an embodiment, each processing module 106 has a power load of the less than 500 watts, e.g., 400 watts or less.

The NIC 202 and the storage controller 204 are each coupled to the processing unit 206. The NIC 202 is configured to receive data from the communication network 102 (FIG. 1, e.g., via load balancer 150). The network interface card may be a communication device configured to communicate data over one or more communication lines, e.g., between the processing modules 106 and the load balancer 150 (FIG. 1). Where the load balancer 150 is a Brocade device, the communication device is configured to communicate with the Brocade device. The communication lines may be optical, Ethernet, or other type of communication lines. Although a single communication line is depicted between each processing module 106 and the load balancer 150, the communication lines may each include multiple lines (e.g., 4 communication lines). The storage controller 204 is configured to access a corresponding SD 104 (FIG. 1). For example, the storage controller 204 of processing module 106a is configured to access SD 104a.

The processing unit 206 is configured to monitor traffic routed to the processing module 106 by the load balancer 150, generate meta-data associated with the monitored traffic (such as time stamps corresponding to the time the traffic was received), and store the all or selected portions of the monitored traffic and/or meta data in the corresponding storage device 104 and/or storage drive 208 via the storage controller 204.

The processing module 106 includes a module chassis 220 housing the processing unit 206, the NIC 202, and the storage controller 204. The module chassis 220 may additionally house the storage drive 208 as illustrated.

FIG. 2B depicts an embodiment of a processing module 106 in further detail in accordance with aspects of the invention. In FIG. 2B, the storage drive 208 includes a pair of solid state drives (SSD 210a and SSD 210b). Other types or drives and fewer or more drives may be used for storage depending on the amount of storage desired. Additionally, in the embodiment depicted in FIG. 2B, a single riser card 212 is used to couple the NIC 202 and the storage controller 204 to a motherboard 214. The processing unit (P.U.) 206 and the storage drive 208 may also be coupled to the motherboard 214. The NIC 202 and the storage controller 204 may each include a connector for coupling to the network 102 (e.g., via a load balancer 150) and storage device(s) 104, respectively, and such connectors may extend outside the body of the module chassis 220 to facilitate connection with the network and storage device(s). In an embodiment, the processing modules 106 may be added and/or removed during operation of the network monitoring system 100 (i.e., the processing modules 106 are hot swappable in/out of the system chassis 120).

The storage controller 204 is configured to move data to and from computer storage devices such as the SD 104 corresponding to the processing module 106 containing the storage controller and/or the storage drive 208 in the processing module 106. The storage controller 204 may be a small computer system interface (SCSI) controller such as a serial attached SCSI (SAS) controller. A SAS controller is a point-to-point serial protocol. Other suitable controllers will be understood by one of skill in the art from the description herein.

According to embodiments, the network interface card 202 may be 2×10G, 4×1G or 4×10G full height (FH) half length (HL) monitoring cards, the storage controllers 204 may be PCI storage controllers, and the processing modules 106 may each support two or more PCIe cards. For a full height NIC 202 the height, h, is approximately 4.2 inches. In an embodiment, the width, w, of the processing module 106 is less than two times the height of a full height NIC 202, e.g., less than 8.4 inches.

FIG. 3 depicts a storage device 104 (e.g., storage device 104a) in accordance with aspects of the invention. Each storage device 104 includes one or more storage units 302a-n. Each storage unit 302 may be a storage medium such as a hard drive, solid state drive, or disk. The multiple storage units 302 may be daisy chained together. The storage units within a storage device may be configured as JBOD (“just a bunch of disks/drives”), a SAN (“storage area network”), etc. In an exemplary embodiment, the system is configured to record information, comprising packets and/or meta data, on the storage units in a RAID (“redundant array of independent disks”) format.

FIG. 4 depicts an embodiment including a management module 106, five processing modules 106, and six power supplies 118 positioned with the chassis 120. In an embodiment, the system chassis has a depth, d, that is less than 31 inches. In other embodiments, a compact solution is provided with the system chassis 120 being in accordance with Network Equipment-Building System (NEBS) standards with a depth, d, that is less than 20 inches. The illustrated management module 104 has a connection surface 500 such as depicted in FIG. 5A and each illustrated processing module 106 has a connection surface 502 such as depicted in FIG. 5B. The connection surface 500 (FIG. 5A) of the management module 104 includes a first management port 504, a second management port 506, a direct access management port (ILO port) 508, and a plurality of connection ports 510 (e.g., Ethernet ports and/ optical links; 4 depicted—labeled 1, 2, 3, and 4) for connection with the processing modules 106 as depicted in FIG. 4. Although not numbered in FIG. 4 for visual clarity, it is understood that the management module 104 of FIG. 4 includes a connection surface such as depicted in FIG. 5A. The connection surface 502 (FIG. 5B) of the processing module 106a includes a first management port 512, a second management port 514, a direct access management port (ILO port) 516, and a plurality of connection ports 518 (e.g., optical links and/or Ethernet ports; 4 depicted solely in 5B) for connection with the load balancer 150 (FIG. 1). Although not numbered in FIG. 4 for visual clarity, it is understood that the processing modules 106 of FIG. 4 each include a connection surface such as depicted in FIG. 5B. It is to be understood that the various connections on the respective surfaces may not be within the same plane. Furthermore, one or more connections may be on other surfaces (e.g., a side service, back surface, etc.).

Referring to FIGS. 4, 5A and 5B, which are used to illustrate one specific implementation, management module 104 is connected to the processing modules directly and/or via the switch 110. Each connection line (line with circle on each end represents a connection (e.g., Ethernet jumper)); and the numbered boxes (1, 2, 3, and 4) in the management module 104 and corresponding numbered boxes in the processing modules 106 (1, 2, 3, and 4) represent a connection therebetween (line connection not shown in the figures). Other implementations for communicating among the management module 104 and the processing modules 106 will be understood by one of skill in the art from the description herein.

The ILO 508 of the management module 104 is connected to a network for direct access management (ILO; dashed line). The ILO 516 of each processing module 106 is coupled to a port on the switch 110. The network depicted in FIG. 4 may be the same network (i.e., communication network 102) for which network traffic is being monitored or a different network (e.g., a management network).

The first management interface 504 of the management module 104 and the first management interfaces 512 of the processing modules 106 are connected to ports on the switch 110. The second management port 506 on the management module 104 is connected to the network for remote management of the management module (Mgt.; solid line). The second management port 514 on one of the processing modules 106 (e.g., processing module 106a) is connected to the network (Backup; dash dot line) to provide a back-up management connection to the management module 104 and/or processing modules in the event the management module 104 is not accessible. The second management port 506 on the remaining processing modules (e.g., processing modules 106b-e) are connected directly to the management module 104 (represented by the numbered blocks).

Each of the processing modules 106 are coupled to the load balancer 150 (FIG. 1) via their connection ports 518 (which are coupled to the NIC 202; FIG. 2B). The processing modules 106 process the network traffic forwarded to them via the load balancer. The processing modules 106 each include at least one storage connection port (e.g., storage ports 520a and 520B) coupled to the storage controller 204 (FIG. 2B) to enable connections with the corresponding storage devices 104. The management module 106 directs the processing modules 106 using the connections described above to aggregate and reports the processed network traffic.

In use, the configurable network monitoring system 100 may be configured by identifying data flow of a target communication network 102, selecting a number of processing modules 106 for processing the data flow, configuring a system chassis 120 of a network monitoring apparatus 105 with the selected number of processing modules 106, and coupling corresponding storage controllers 204 to the respective processing modules 106. In accordance with one aspect of the invention, the network monitoring apparatus 105 may be seamlessly upgraded by attaching additional storage devices/units and/or adding additional processing modules 106 under control of the management module 108. For example, a system chassis 120 may have capacity for the management module 108 and up to five processing modules 106. The system may first be configured with a single processing module 106 and no management module 108. In an exemplary embodiment the system is first be configured with the management module 108 and two processing modules 106. If each processing module 106 is capable of processing traffic from a 20G communication line, the system may have a capacity of 40G. At a later time when additional capacity is required, one or more additional processing modules 106 (and corresponding storage devices 104) may be added to increase the traffic processing capacity of the system 100.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A configurable network monitoring system comprising:
a. a plurality of storage devices;
b. a network monitoring apparatus including a plurality of processing modules, each processing module having:
i. a processing unit,
ii. a network interface card coupled to the processing unit and configured for receiving data from a communication network,
iii. a storage controller coupled to the processing unit and configured to access a corresponding one of the plurality of storage devices, and
iv. a module chassis housing the processing unit, the network interface card and the storage controller; and
c. a system chassis housing the plurality of processing modules.

2. A system according to claim 1, wherein the network monitoring apparatus further includes:
a. a management module; and
b. a switch coupling the management module to the plurality of processing modules.

3. A system according to claim 1, wherein for each processing module:
a. the network interface card is coupled to the processing unit via a PCIe interface; and
b. the storage controller is a SAS controller.

4. A system according to claim 1, wherein the plurality of processing modules are hot swappable.

5. A system according to claim 2, further comprising a load balancer that distributes data received from the communication network among the plurality of processing modules via their respective network interface card.

6. A system according to claim 5, wherein the load balancer distributes the received data responsive to characteristics of the data. (e.g., logical grouping of traffic).

7. A system according to claim 5 wherein the load balancer distributes data received from the communication network responsive to a level of availability of each of the plurality of processing modules.

8. A system according to claim 1 wherein each of the plurality of processing modules comprises one or more storage drives.

9. A system according to claim 2 wherein the management module comprises one or more storage drives.

10. A system according to claim 1 wherein the network monitoring apparatus has a depth less than 31 inches.

11. A system according to claim 1 wherein each processing module has a power load of less than 500 watts.

12. A system according to claim 1 wherein the network interface cards are full height cards and the processing modules have a width less than two times the height of the network interface cards.

13. A system according to claim 1 wherein the network interface card and storage controller of each processing module are coupled to the processing unit via a single riser card.

14. A system according to claim 1 wherein the management module includes a virtual interface corresponding to one or more inputs of the load balancer.
